(19) United States
(12) Patent Application Publication
(10) Pub. No.: US 2026/0251602 A1
(43) Pub. Date: Aug. 27, 2026

(54) GAS SENSOR

(71) Applicant: NISSHINBO MICRO DEVICES, INC., Tokyo (JP)

(72) Inventors: Takahide USUI, Saitama (JP); Yo KUBOTA, Saitama (JP); Naoki KIKUCHI, Saitama (JP); Nobuhiko Fujii, Saitama (JP); Satoru Ono, Saitama (JP)

(73) Assignee: NISSHINBO MICRO DEVICES, INC., Tokyo (JP)

(21) Appl. No.: 18/874,656

(22) PCT Filed: May 2, 2023
(86) PCT No.: PCT/JP2023/017164

§ 371 Date: Dec. 13, 2024

(30) Foreign Application Priority Data
Jun. 17, 2022 (JP) 2022-098423

(51) Int. Cl. G01N 27/12

(52) U.S. Cl. CPC G01N 27/12

(57) ABSTRACT

This disclosure is a gas sensor including a substrate, an opening part with which the substrate is equipped, a membrane covering the opening part, a sensor unit, with which the membrane above the opening part is equipped, for detecting a gas, a heater, with which the membrane above the opening part is equipped, for heating the sensor unit, and at least one slit, with which the membrane is equipped, overlapping with an outer periphery of the sensor unit and the heater.

### TECHNICAL FIELD

This disclosure relates to a gas sensor.

### BACKGROUND ART

There has been proposed a gas sensor that detects a gas based on a change of an electric property of a sensing film that reacts with the gas (for example, see Patent Literature 1). In Patent Literature 1, a supporting film of a heater that heats the sensing film to a specific temperature is formed of a glass having small heat loss, thereby avoiding dissipation of heat into the supporting film side.

### CITATION LIST

### Patent Literature

Patent Literature 1: Japanese Patent No. 2582343

### SUMMARY OF INVENTION

### Technical Problem

In Patent Literature 1, while the heat of the heater is less likely to be dissipated from the supporting film, the heat is transferred in an insulation film on which the heater and a temperature sensor are mounted. Therefore, in a closed membrane structure as described in Patent Literature 1, since the heat of the sensing film heated by the heater is transferred through and dissipated from the insulation film, an increase of power consumption has been a problem.

Thus, it is an object of the present disclosure to reduce an amount of heat dissipated from an insulation film.

### Solution to Problem

A gas sensor of this disclosure includes a substrate, an opening part with which the substrate is equipped, an insulation film covering the opening part, a sensor unit, with which the insulation film above the opening part is equipped, for detecting a gas, a heater, with which the insulation film above the opening part is equipped, for heating the sensor unit, and at least one slit, with which the insulation film is equipped, overlapping with an outer periphery of the sensor unit and the heater.

In the gas sensor of this disclosure, a terminating end of the slit may be located on the sensor unit side in comparison with an attachment area of the insulation film on the substrate.

For example, the insulation film is a closed membrane with which an insulation film located above the opening part is incorporated into a continuum.

For example, the insulation film is a suspended membrane anchored, with three or more anchors, to an insulation film attached to the substrate.

The opening part may be a through-hole bored through the substrate, or a bottomed cavity, bored in the substrate, on the insulation film side.

The sensor unit includes a sensing film for a gas, and an electrode, located under the sensing film, for measuring an electric property of the sensing film.

In this disclosure, an embodiment in which the heater is located below the electrode with at least one insulation film interposed therebetween, a temperature sensor for measuring a temperature is provided at a same layer as the heater, and the other insulation film or films are located below the heater and the temperature sensor may be employed.

The sensor unit may include one or more sensor units mounted on the insulation film, and each of the sensor units may be equipped with the slit.

The slit may equidistantly spread out from the sensor unit. The sensor unit may have a circular shape. In this regard, the slit may have a shape with a curve along the outer periphery of the sensor unit.

The gas sensor of this disclosure may further include a second substrate superimposed over the substrate and on the sensor unit side, and penetrated by an opening part inside which the sensor unit is surrounded therewith.

The above-described respective disclosures can be combined as much as possible.

### Advantageous Effects of Invention

Since the gas sensor of this disclosure is equipped with the slit that blocks the heat transferred through the insulation film, the amount of heat dissipated from the insulation film can be reduced.

### BRIEF DESCRIPTION OF DRAWINGS

FIG. 1 illustrates an exemplary configuration of a gas sensor of this disclosure.

FIG. 2 illustrates an exemplary cross-sectional structure taken along a line A-A′.

FIG. 3 illustrates an example of cross-sectional structures of the gas sensor of this disclosure, FIG. 3(a) illustrates a cross-sectional structure taken along a line B-B′, and FIG. 3(b) illustrates a cross-sectional structure taken along a line C-C′.

FIG. 4 illustrates examples of stress applied to a membrane, FIG. 4(a) illustrates an example where a short slit is employed, and FIG. 4(b) illustrates an example where a long slit is employed.

FIG. 5 illustrates an exemplary configuration of a sensor unit.

FIG. 6 illustrates exemplary variations of the slit.

FIG. 7 illustrates an exemplary configuration of the gas sensor of this disclosure.

FIG. 8 illustrates an exemplary manufacturing process of the gas sensor of this disclosure.

FIG. 9 illustrates an exemplary configuration of the gas sensor of this disclosure.

FIG. 10 illustrates an exemplary cross-sectional structure taken along a line D-D′.

FIG. 11 illustrates an exemplary cross-sectional structure taken along the line D-D′.

FIG. 12 illustrates an exemplary structure of a multi-layer substrate.

### DESCRIPTION OF EMBODIMENTS

The following describes embodiments of this disclosure in detail by referring to the drawings. This disclosure is not limited to the embodiments described below. These embodiments are merely examples, and this disclosure can be embodied with various changes and modifications on the basis of the knowledge of those skilled in the art. In this Description and the drawings, components having the same reference numeral are mutually the same.

### First Embodiment

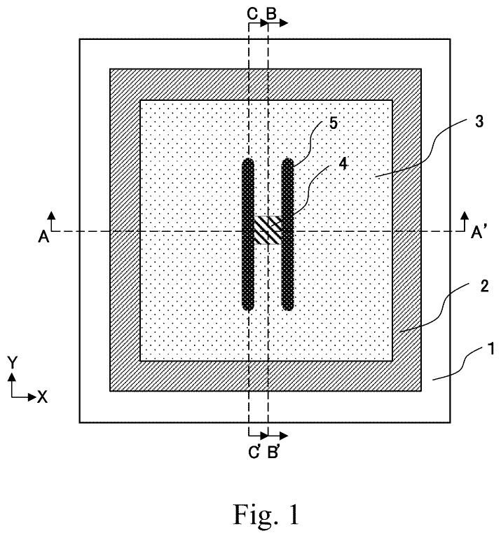

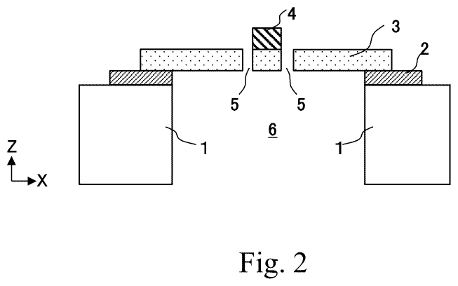

FIG. 1 and FIG. 2 illustrate an exemplary configuration of a gas sensor of this disclosure. FIG. 1 is a plan view of the gas sensor, and FIG. 2 illustrates a cross-sectional structure taken along a line A-A′. The drawings illustrate an example in which a membrane 3 is a closed membrane with which an insulation film located above an opening part 6 is incorporated into a continuum. The gas sensor of this embodiment includes a substrate 1, an opening part 6 with which the substrate 1 is equipped, the membrane 3 formed of an insulation film that covers the opening part 6, a sensor unit 4 that detects a gas, and at least one slit 5.

The opening part 6 is a void applied to a surface, on which the membrane 3 would be located, of the substrate 1, and may penetrate the substrate 1, or may extend inward with a bottom part of the substrate 1 left. The drawing illustrates an example of a structure in which the substrate 1 is penetrated. With the sensor unit 4, the membrane 3 above the opening part 6 is equipped.

The slit 5 is an elongated through-hole penetrating the membrane 3 in a thickness direction. At least one or more slits 5 overlapping with an outer periphery of the sensor unit 4 are bored through the membrane 3 of the outer periphery of the sensor unit 4. In this embodiment, an example in which the slits 5 extending in a Y-axis direction and overlapping with both sides, in an X-axis direction, of the outer periphery of the sensor unit 4 is described. An end part of each of the slits 5 may be round like a circular shape, or may be rectangular-shaped.

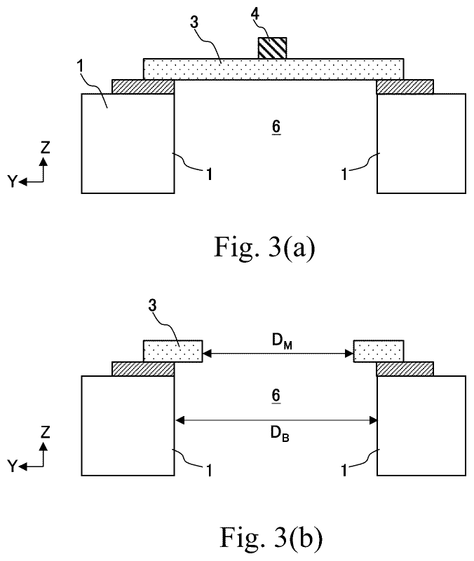

FIG. 3(a) illustrates an example of a cross-sectional structure taken along a line B-B′, on the Y-axis, passing across the sensor unit 4. FIG. 3(b) illustrates an example of a cross-sectional structure taken along a line C-C′ passing across the slit 5. Each terminating end of the slit 5 is, as illustrated FIG. 3(b), located on center side of the substrate 1 in comparison with the attachment area of the membrane 3 on the substrate 1. A width of the opening part 6 can be set to any value more than that of the sensor unit 4 is set to, and in this embodiment, an example in which a width in the Y-axis direction is DB is illustrated. As a length DM of the slit 5 in the Y-axis direction, any value longer than the width of the sensor unit 4 and shorter than the width DB can be employed.

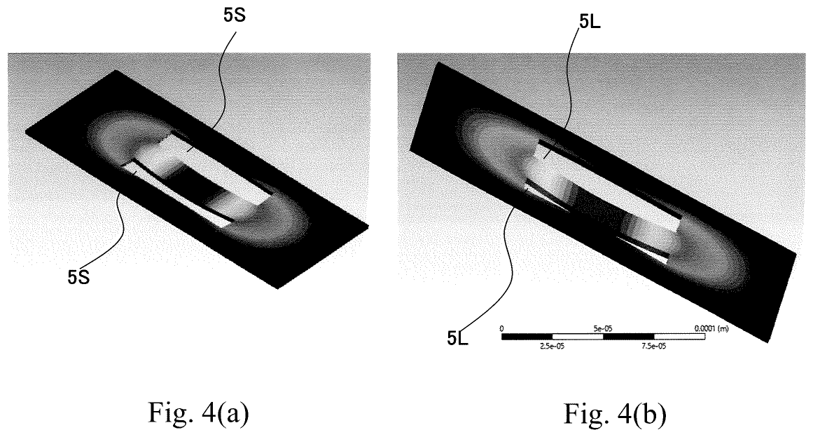

FIG. 4 illustrates comparison between examples of the length of the slit 5. The drawings illustrate examples in which the end part of the slit 5 has the rectangular shape. The drawings show that a short slit 5S mitigates an influence of stress applied to the part, on which the sensor unit 4 is located, in comparison with a long slit 5L. Additionally, the short slit 5S makes a stress applied to the end parts of the slit 5 smaller and makes a range narrower than the long slit 5L makes. Accordingly, the adjustment of the length of the slit 5 is understood to enable enhancement of the strength of the part, on which the sensor unit 4 is located, of the membrane 3 and stable installation of the sensor unit 4.

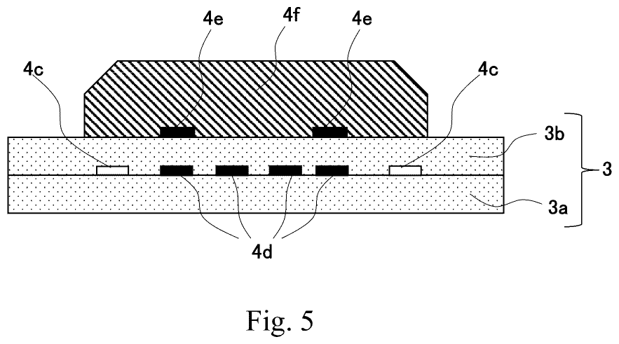

FIG. 5 illustrates an exemplary configuration of the sensor unit 4. As the sensor unit 4, any configuration capable of detecting a gas can be employed. For example, the sensor unit 4 includes a sensing film 4f, electrodes 4e, heaters 4d, and temperature sensors 4c. In this embodiment, an example in which the membrane 3 includes a lower membrane 3a and an upper membrane 3b, and the sensing film 4f and the electrodes 4e are located on the upper membrane 3b is described.

The sensing film 4f contains a gas sensing material, such as a metal oxide film. The electrodes 4e are located under the sensing film 4f, and measure an electric property of the sensing film 4f. The heaters 4d are located below the electrodes 4e with at least one insulation film interposed therebetween. In this embodiment, an example in which the at least one insulation film is the upper membrane 3b is described. The heaters 4d heat the sensing film 4f. The temperature sensors 4c are located in the proximity of the heaters 4d, and measure the temperature.

In the gas sensor, to improve sensitivity, the temperature of the sensing film 4f may be rapidly raised. In this embodiment, since the slits 5 reduce a contact area between the sensor unit 4 and the membrane 3, the temperature of the sensor unit 4 is less likely to be diffused by transferring through the membrane 3. Therefore, the gas sensor of this embodiment is capable of efficiently raising the temperature rapidly.

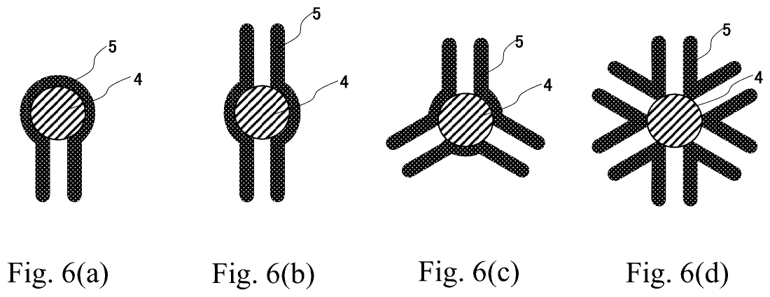

FIG. 6 illustrates exemplary variations of slits 5. The sensor unit 4 can have any shape: FIG. 1 illustrates an example of a rectangular shape and FIG. 6 illustrates an example of a circular shape. At least one or more slits 5 overlapping with the outer periphery of the sensor unit 4 are bored. The slits 5 may be linear or curved, or may be partially curved. For example, as illustrated in FIG. 6(a) and FIG. 6(b), the slits 5 may be partially curved along the outer periphery of the sensor unit 4. Each of the slits 5 may have any length, and may equidistantly spread out from the sensor unit 4 as illustrated in FIG. 1, FIG. 6(b), FIG. 6(c), and FIG. 6(d).

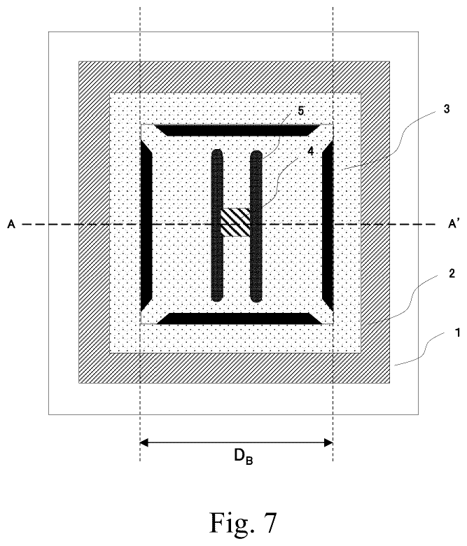

Although the example in which the membrane 3 is a closed membrane is described in this embodiment, this disclosure is not limited thereto, and any embodiment in which the terminating end of the slit 5 is located on the sensor unit 4 side in comparison with the attachment area of the membrane 3 on the substrate 1 is can be employed. Specifically, as illustrated in FIG. 7, a suspended membrane anchored, with three or more anchors, to the membrane 3 attached to the substrate 1 may be used.

As described above, according to this embodiment, since the slit 5 does not extend to the substrate 1, concentration of internal stress caused by an external force and/or temperature rise or temperature fall can be reduced. When the membrane 3 is the closed membrane or the suspended membrane, the gas does not easily go around to a back surface of the membrane 3, and the gas introduced from an upper area of the substrate 1 can be efficiently supplied to the sensing film 4f. Further, in this disclosure, since the low-temperature gas introduced from the upper area of the substrate 1 does not easily go around to the back surface of the membrane 3, the temperature fall of the sensing film 4f can be controlled.

### Second Embodiment

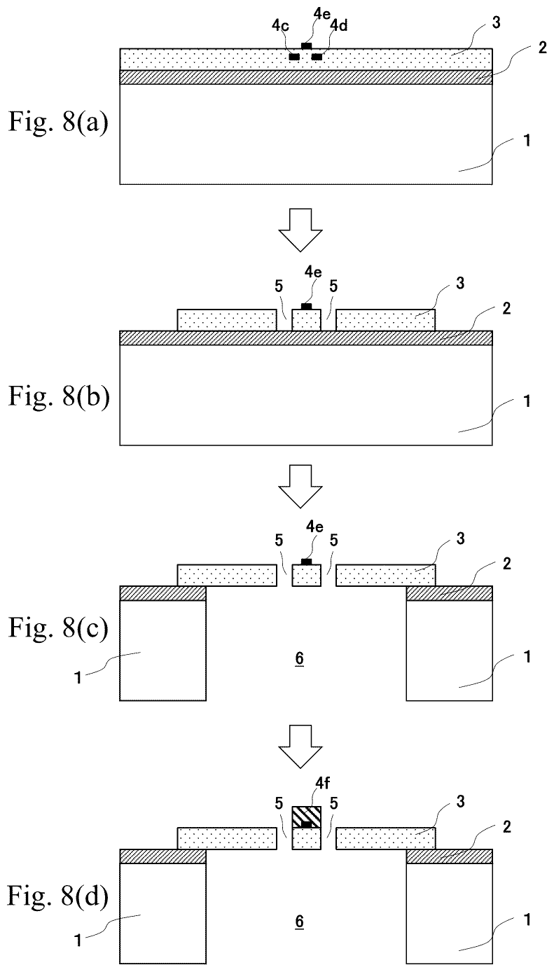

In this embodiment, a method for manufacturing the gas sensor of this disclosure is described by referring to FIG. 8. The substrate 1 is, for example, a silicon substrate, and an SiO2 film with a thickness of 5000 A is formed on the whole surface of the silicon substrate by thermal oxidation. Alternatively, a plasma oxide film may be formed, and have a thickness within a range of 0.1 μm to 2 μm (FIG. 8(a)).

Next, at least one or more layers of CVD film 2 are formed (FIG. 8(a)). The CVD film 2 may be an oxide film, a decompression nitride film, or an SiON film. A thickness of the formed CVD film 2 is, for example, within a range of 0.1 μm to 2 μm.

Next, the membrane 3, the heater 4d, the temperature sensor 4c, and the electrode 4e are formed (FIG. 8(a)). Here, the membrane 3 includes, as illustrated in FIG. 5, the lower membrane 3a and the upper membrane 3b, and the heaters 4d and the temperature sensors 4c are formed between the lower membrane 3a and the upper membrane 3b.

In the formation of the heaters 4d and the temperature sensors 4c on the lower membrane 3a, for example, Pt is formed by a sputtering method, the heaters 4d or the temperature sensors 4c are patterned by a photolithography method, and the removal is performed by a dry etching method. The patterning may be performed by the photolithography method at first, before Pt is formed by the sputtering method and a patterning and a lift-off process are subsequently performed: Pt may be formed by an evaporation method. As the material of the heater 4d or the temperature sensor 4c, not only Pt, but also W may be used, and polysilicon may be used. As an adhesive layer between the upper membrane 3b and the lower membrane 3a, Ti or TiN may be formed, Cr may be formed, and/or Si may be formed. The thicknesses of the formed heater 4d and the formed temperature sensor 4c are, for example, within a range of 0.1 μm to 2 μm each.

The formation of the electrode 4e on the upper membrane 3b is similar to the formation of the heater 4d and the temperature sensor 4c. However, the thickness of the formed electrode 4 e is, for example, within a range of 0.1 μm to 1 μm.

After the formation of the electrode 4e, the membrane 3 is subsequently equipped with the slits 5 (FIG. 8(b)). In this drawing and the following drawings, depiction of the heater 4d and the temperature sensor 4c is omitted. Using the photolithography method, patterning is performed along the shape of the slit 5 overlapping with an outer periphery of a spot at which the sensing film 4f is positionable, and the membrane 3 is removed by the dry etching method. Regarding the removal of the membrane 3, a wet etching method may be used for the removal, or ion milling may be performed for the removal.

Subsequently, the substrate 1 is equipped with the opening part 6 (FIG. 8(c)). Specifically, a back surface of the substrate 1 is polished to turn the thinned substrate 1 having a desired thickness, patterning is performed on the back surface of the substrate 1 using the photolithography method, and the dry etching is performed. Thus, the opening part 6 penetrating the substrate 1 is bored, and the slit 5 is uncovered. The substrate 1 may be removed by the wet etching method, and the patterning may be performed on a front surface of the substrate 1 to remove the substrate 1 from the front surface.

Subsequently, the sensing film 4f is formed (FIG. 8(d)). Specifically, the sensing film 4f is applied over the electrode 4e, and sintered by annealing. The application of the sensing film 4f can be performed by, for example, an inkjet method or a dispense method. The sensing film 4f can be formed also by the sputtering method. The thickness of the sensing film 4f is a thickness optimized to detect a desired gas, and the material of the sensing film 4f may be, especially, a metal oxide film, may be an SnO2 film, or may be WO3.

By performing the above-described processes, the gas sensor of Embodiment 1 can be manufactured.

### Third Embodiment

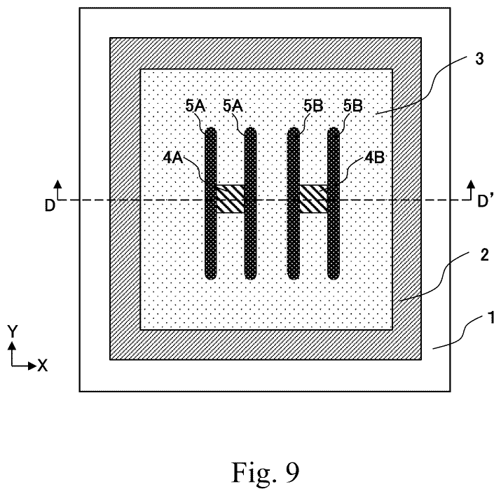

FIG. 9 illustrates an exemplary configuration of the gas sensor of this disclosure. In the gas sensor of this embodiment, the membrane 3 is equipped with two sensor units 4A and 4B. In this disclosure, in boring the opening part 6 illustrated in FIG. 8(c), the substrate 1 below a membrane 3C between the sensor units 4A and 4B may be removed or may be left.

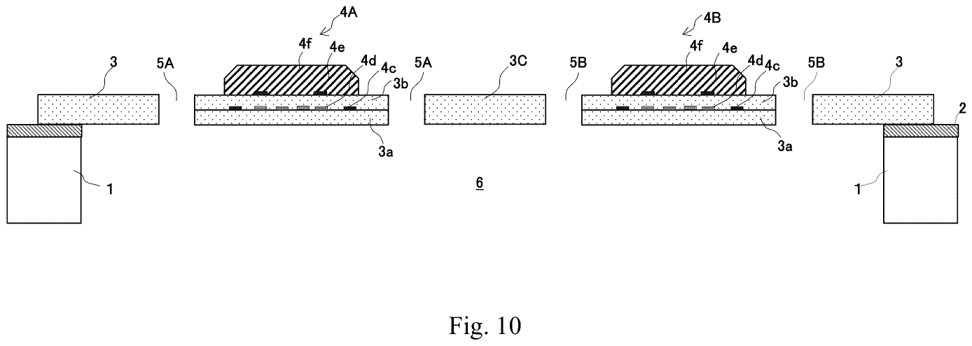

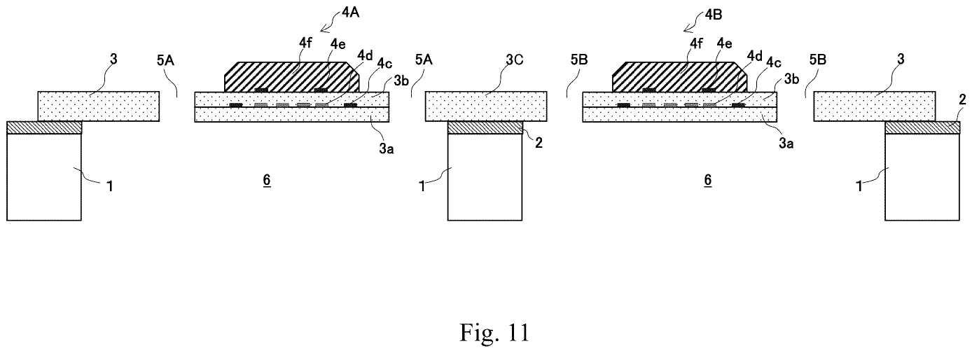

FIG. 10 and FIG. 11 illustrate exemplary cross-sectional structures taken along a line D-D′. For example, as illustrated in FIG. 10, the opening part 6 may occupy a space under the membrane 3C. As illustrated in FIG. 11, the substrate 1 may occupy a space under the membrane 3C.

In this embodiment, even though the two or more sensor units 4 are mounted on the membrane 3, the membrane 3C is located between the sensor units 4A and 4B. Therefore, in this disclosure, the gas can be efficiently introduced to the surface of the membrane 3.

Furthermore, in the gas sensor of this disclosure, when the two or more sensor units 4A and 4B are mounted on the membrane 3, the membrane 3C is located between the sensor units 4 can prevent the gas from easily flowing into the back surface of the membrane 3 under the sensor units 4A and 4B, and cooling by the introduced gas can be controlled.

### Fourth Embodiment

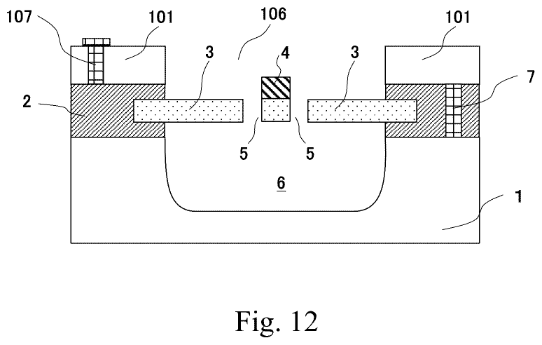

FIG. 12 illustrates an exemplary cross-sectional structure of the gas sensor of this embodiment. The gas sensor of this embodiment has a multi-layer structure in which a plurality of substrates are superimposed. FIG. 12 illustrates an example in which, in the gas sensor illustrated in FIG. 2, a substrate 101 is, on the sensor unit 4 side, superimposed over the substrate 1, and connected to an electrode 7 and a through electrode 107 as one example.

The substrate 101 is penetrated by an opening part 106 inside which the sensor unit 4 is surrounded therewith. Accordingly, inside the opening part 106, the sensor unit 4 can be efficiently reacted with the gas. The shape of the opening part 106 along an XY plane may be any shape, and may be the same as or different from that of the opening part 6. The shape of the opening part 106 along the XY plane may be a shape that causes a constant flow of the gas toward the sensor unit 4.

This embodiment can be produced by equipping the substrate 101 with a wiring, boring the opening part 106, forming the through electrode 107, and joining the substrate 101 to the gas sensor illustrated in FIG. 2. The joining may be metal joining or room-temperature joining. To transfer the electric potential between the upper and lower substrates 1, a plurality of substrates may be connected via the electrode 7.

The opening part 6 of this disclosure, as illustrated in FIG. 12, may be a bottomed cavity, bored in the substrate 1, on the membrane 3 side.

### REFERENCE SIGNS LIST

1 Substrate
2 CVD film
3 Membrane
3a Lower membrane
3b Upper membrane
4, 4A, 4B Sensor unit
4c Temperature sensor
4d Heater
4e, 7 Electrode
4f Sensing film
5 Slit
6, 106 Opening part
107 Through electrode

1. A gas sensor comprising:
a substrate;
an opening part with which the substrate is equipped;
an insulation film covering the opening part;
a sensor unit, with which the insulation film above the opening part is equipped, for detecting a gas;
a heater, with which the insulation film above the opening part is equipped, for heating the sensor unit; and
at least one slit, with which the insulation film is equipped, overlapping with an outer periphery of the sensor unit and the heater.

2. The gas sensor according to claim 1, wherein
a terminating end of the slit is located on the sensor unit side in comparison with an attachment area of the insulation film on the substrate.

3. The gas sensor according to claim 1, wherein
the insulation film is a closed membrane with which an insulation film located above the opening part is incorporated into a continuum.

4. The gas sensor according to claim 1, wherein
the insulation film is a suspended membrane anchored, with three or more anchors, to an insulation film attached to the substrate.

5. The gas sensor according to claim 1, further comprising
a second substrate superimposed over the substrate and on the sensor unit side, and penetrated by an opening part inside which the sensor unit is surrounded therewith.

6. The gas sensor according to claim 1, wherein
the opening part is:
a through-hole bored through the substrate; or
a bottomed cavity, bored in the substrate, on the insulation film side.

7. The gas sensor according to claim 1, wherein
the sensor unit comprises:
a sensing film for a gas; and
an electrode, located under the sensing film, for measuring an electric property of the sensing film, wherein
the heater is located below the electrode with at least one insulation film interposed therebetween,
a temperature sensor for measuring a temperature is provided at a same layer as the heater, and
the other insulation film or films are located below the heater and the temperature sensor.

8. The gas sensor according to claim 1, wherein
the sensor unit comprises one or more sensor units mounted on the insulation film, and
each of the sensor units is equipped with the slit.

9. The gas sensor according to claim 1, wherein
the slit equidistantly spreads out from the sensor unit.

10. The gas sensor according to claim 1, wherein
the sensor unit has a circular shape, and
the slit has a shape with a curve along the outer periphery of the sensor unit.
